(19) United States
(12) Patent Application Publication
(10) Pub. No.: US 2026/0168829 A1
(43) Pub. Date: Jun. 18, 2026

(54) NOZZLE MANIFOLD ASSEMBLY

(71) Applicant: The Aerospace Corporation, El Segundo, CA (US)

(72) Inventor: James M. HELT, Playa del Rey, CA (US)

(73) Assignee: The Aerospace Corporation, El Segundo, CA (US)

(21) Appl. No.: 19/302,285

(22) Filed: Aug. 18, 2025

Related U.S. Application Data
(63) Continuation-in-part of application No. 18/986,367, filed on Dec. 18, 2024.

(51) Int. Cl. G01F 1/42; G01F 1/50; G01N 11/00; G01N 11/08

(52) U.S. Cl. CPC G01F 1/42; G01F 1/50; G01N 11/08; G01N 2011/008; G01N 2011/0093

(57) ABSTRACT

A nozzle manifold assembly (NMA) for a refractive imaging lens (RIL) includes a nozzle manifold (“manifold”) and a nozzle being part of the NMA. For example, the NMA and the RIL may be used in constructing fluid inspection and analysis instruments like RIL based thin film viscometers (RIL-TFVs). The manifold is configured to accept gas and/or liquid supply to form a jet, and configured to mount to the nozzle. The manifold may include a plurality of sensors configured to measure and/or control one or more properties of the NMA, the RIL, and/or the jet. The NMA also includes a gas supply connected to, and supplying gas through, the manifold to form the jet.

### CROSS REFERENCE TO RELATED APPLICATIONS

This application claims priority to, and is a continuation-in-part of, U.S. application Ser. No. 18/986,367, filed on Dec. 18, 2024. The subject matter of the related application is incorporated herein by reference.

### FIELD

The present invention relates to an imaging lens for inspection and analysis, and more particularly, to a nozzle manifold assembly (NMA) for refractive imaging lens (RIL).

### BACKGROUND

National Security Space (NSS) utilizes specialty fluids in a range of applications where they serve to lubricate tribological contacts, as coatings precursors, as heat transfer media, as dampening and hydraulic fluids. For instance, when a spacecraft moving mechanical assembly (MMA) is placed in space, including a control moment gyroscope (CMG) or reaction wheel assembly (RWA), there is often a finite supply of lubricant.

Due to the finite lubricant supply, it is important to understand how the quantity and physical properties of the MMA's lubricant evolves over time during operation in space. This process of evolution includes understanding changes in the lubricant's viscosity due to tribological degradation, which directly impacts how much lubricant life may be left for optimal performance.

It should also be noted that it is important to understand why a lubricant's local viscosity is critical to tribology. For example, the change in the lubricant's viscosity with use correlates to the lubricant's health, the remaining “life” of the lubricant, and the counterbody tribological performance. In one example, a lubricant's viscosity is a key physical property found in elastohydrodynamic lubrication (EHL) theory that is used to model and predict attitude control mechanism bearing performance. Changes to a lubricant's viscosity impact EHL film thickness and entrainment dynamics calculations.

Accordingly, there is a need to develop a technique to measure space-based liquid (e.g., fluid lubricant) physical property evolution.

### SUMMARY

Certain embodiments of the present invention may provide solutions to the problems and needs in the art that have not yet been fully identified, appreciated, or solved by current liquid evolution measurement technologies. For example, some embodiments of the present invention pertain to a nozzle manifold assembly (NMA) for refractive imaging lens (RIL). In some embodiments, the NMA and the RIL are two separate components that are combined to form the RIL NMA device. In another embodiment, the RIL NMA device is designed and constructed as a single component that includes NMA and RIL features needed for a particular inspection-analysis application. The RIL NMA device is used to construct the RIL based thin film viscometers (RIL-TFVs), which can measure the interfacial-rheological-optical properties of thin fluid films and the surfaces that they coat.

In one embodiment, a nozzle manifold assembly (NMA) for a refractive imaging lens (RIL) includes a nozzle manifold (“manifold”) and a nozzle being part of the NMA. The manifold is configured to accept gas and/or liquid supply to form a jet, and configured to mount to the nozzle. The manifold may include a plurality of sensors configured to measure and/or control one or more properties of the NMA, the RIL, and/or the jet. The NMA also includes a gas supply connected to, and supplying gas through, the manifold to form the jet.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting its scope, the invention will be described and explained with additional specificity and detail through the use of the accompanying drawings, in which:

FIGS. 1A and 1B are generalized diagrams illustrating a close-up and plan (top) view of the RIL NMA's nozzle and the relative geometric arrangement to a substrate coated with a thin fluid film, according to an embodiment of the present invention.

FIGS. 2A-D are diagrams illustrating various views of a RIL NMA, according to an embodiment of the present invention.

FIG. 3A-D are diagrams illustrating various views of a RIL NMA using a planar nozzle, according to an embodiment of the present invention.

FIG. 4A-D are diagrams illustrating various views of an alternative RIL NMA using a planar nozzle, according to an embodiment of the present invention.

FIGS. 5A-C are diagrams illustrating a configuration for triangulating the RIL NMA's position with a position sensitive detector (PSD), according to an embodiment of the present invention.

FIG. 6 is a diagram illustrating a camera triangulation schematic of a RIL NMA, according to an embodiment of the present invention.

FIGS. 7A and 7B show images illustrating the use of camera triangulation, according to an embodiment of the present invention.

FIGS. 8A-D are diagrams illustrating various views of a RIL NMA with an integrated heat-cooling features for temperature control, according to an embodiment of the present invention.

FIGS. 9A-C are diagrams illustrating use of the RIL NMA with a smartphone and a stage with a vertical stand being used to mount and couple the RIL NMA to the smartphone, according to an embodiment of the present invention.

FIGS. 10A-D are diagrams illustrating use of a modular RIL NMA configuration with a smartphone, with two separate mounts and stands for independent vertical and angular positioning of the RIL, smartphone and NMA, according to an embodiment of the present invention.

### DETAILED DESCRIPTION OF THE EMBODIMENTS

Some embodiments of the present invention pertain to a nozzle manifold assembly (NMA) for refractive imaging lens (RIL) that is intended to be used to construct RIL NMA based thin film viscometers (RIL-TFVs) capable of measuring the interfacial-rheological-optical properties of thin fluid films and the surfaces that they coat. In these embodiments, NMA includes multiple features and components that facilitate mounting (or incorporating) the NMA to (or within) a RIL used with film thickness and optical inspection instruments. For these instruments the NMA facilitates alignment, preferably coaxial, of the film thickness measurement location and or optical image with a normal impinging jet's stagnation point, and the simultaneous monitoring and control of the impinging jet, RIL and NMA components. NMA attributes are preferred for construction of RIL-TFV instruments as they enable routine, local physical property analysis of fluids resting on solid material surfaces relevant to space mechanisms, simplify the measurement process, expand measurement protocols, improve measurement accuracy and precision, and ease theoretical analysis.

NMAs may be configured or designed in various ways depending on the RIL's design, application needs, and geometric constraints imposed by the RIL optical system and the article under analysis. For example, the RIL NMA may be used in constructing a RIL-TFV with a custom or suitably sealed, off-the-shelf RIL like microscope objectives. Custom RIL NMAs include designs that incorporate the NMA features directly into RIL structural elements such as the housing or barrel. In another example, NMA devices can be mounted to off-the-shelf RILs and therefore integrate directly with commercial film thickness instruments, enabling measurements of fluid-coated articles with a direct line of sight.

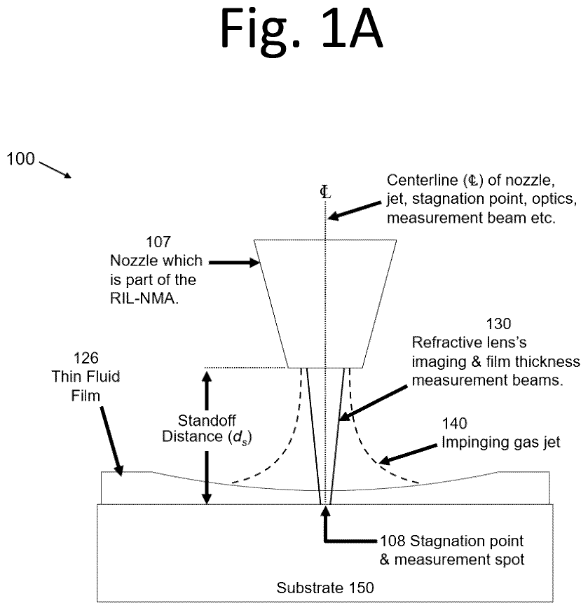

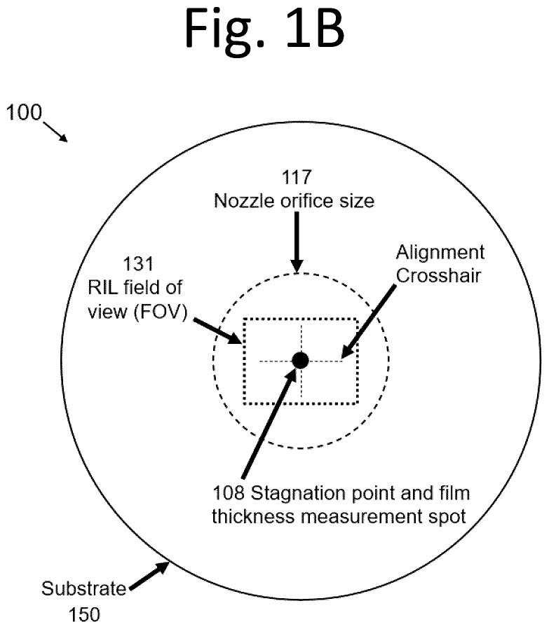

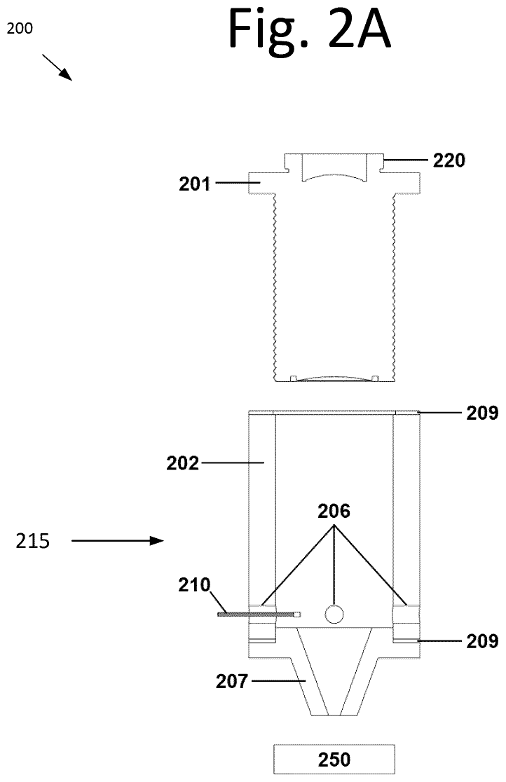

FIGS. 1A and 1B are diagrams illustrating an RIL NMA 100, according to an embodiment of the present invention. In some embodiments, RIL NMA 100 includes a nozzle 107 with a centerline of nozzle, jet, stagnation point (and film thickness measurement spot) 108, and optical and measurement beam. An imaging and film thickness measurement beam (“measurement beam”) 130 is transmitted down the center of, and is configured to be emitted out of the center of, nozzle 107. RIL NMA 100 make measurements, with measurement beam 130, passing through the center of the nozzle 107 orifice (hole/bore). In some embodiments, emitted out of nozzle 107 is an impinging gas jet 140 that impinges orthogonal on surface of thin film fluid 126. Below thin film fluid 126, is a substrate 150. For purposes of explanation, the terms “gas jet”, “impinging gas jet” and “fluid jet” may be used interchangeably. Thin fluid film 126 may be reduced in thickness as gas jet 140 impinges thereon. It should be appreciated that, depending on the embodiment, any fluid which impinges on the surface of thin fluid film 126, may be used (e.g. gas, liquid). Although not illustrated in this embodiment, mounted on or within the RIL NMA is a lens, window, nozzle 107, and sensors, to name a few. Additionally, and as depicted in FIGS. 1A-B, the nozzle 107, jet 140, jet stagnation point 108, optical and measurement beam 130 are in coaxial alignment, and therefore the centers of the jet stagnation point 108 and measurement spot are aligned.

In fluid dynamics, the location at which the fluid (or gas) jet 140 impinges on the surface (or coating) of thin fluid film 126 is called the stagnation point 108 and is a unique area of impinging gas jet 140. The theoretical background of stagnation point flow is described in literature and allows for the viscosity of the fluid to be measured from film thickness (h)−time (t) series data.

It should be appreciated that thin film viscometer (TFV) type instruments use stagnation flow models to measure a fluid's viscosity (η) and/or the jet's hydrodynamic constant (a). For Stokes flow, both parameters are contained in G which is termed the strength of the stagnation flow, as shown in Equation (1) below.

$$h ( t ) = \frac{{h}_{0}}{1 + {h}_{0} Gt} \qquad Equation ( 1 )$$

To construct and use TFV for viscosity measurements, a calibration curve of the jet's hydrodynamic constant (a) is determined using fluids of known viscosities. Next, measuring and fitting h(t) thinning profiles is performed as a function of relevant parameters including the type of gas used (e.g. nitrogen), gas properties, gas flow rate (Q), nozzle geometry and standoff distance (dₛ). Standoff distance (dₛ) is the distance between the substrate surface (i.e., not the surface of the thin fluid film) and the tip of the nozzle. Once calibrated, h(t) thinning profiles of thin fluid films is measured, and the fluids viscosity is calculated by data fitting.

As shown in FIG. 1B, the plan (top) view shows the locations of RIL's image field of view (FOV) 131, size of nozzle orifice 117, jet stagnation point 108, and film thickness measurement spot when coaxially aligned. It should be noted that the term “when coaxially aligned” is used, because there are various ways to measure the film's thickness when using the RIL NMA. For example, fiber optic spectral reflectance and ellipsometry make measurements at a specific spot like shown in the FIGS. 1A and 1B. In principle, one can move this measurement spot around in the image frame if they want. A person of ordinary skill in the art may do this if they're interested in making measurements outside the stagnation zone. It should be noted that the terms stagnation “zone” and “point” can be used interchangeably. Other film thickness techniques, such as interferometry, can determine the film's thickness anywhere in the image frame including the stagnation point which is preferably at the center of the image. Also shown in FIG. 1B is the alignment crosshairs, which are overlayed on digital video images obtained when using the RIL NMA with, for example, a microscope or other imaging system. These digital video images may be acquired and analyzed by a personal computer (PC). The size of nozzle orifice 117 in this embodiment may be larger than FOV 131, and part of the impingement area may be observed during the film thinning process. In such an embodiment, the stagnation point may be observed in the image of the RIL, allowing for measurements to be performed. Depending on the design and configuration, different types of nozzles 107 may be used. These nozzles may include orifices of varying sizes, number and arrangement. In those embodiments, the impingement area may be smaller than FOV 131.

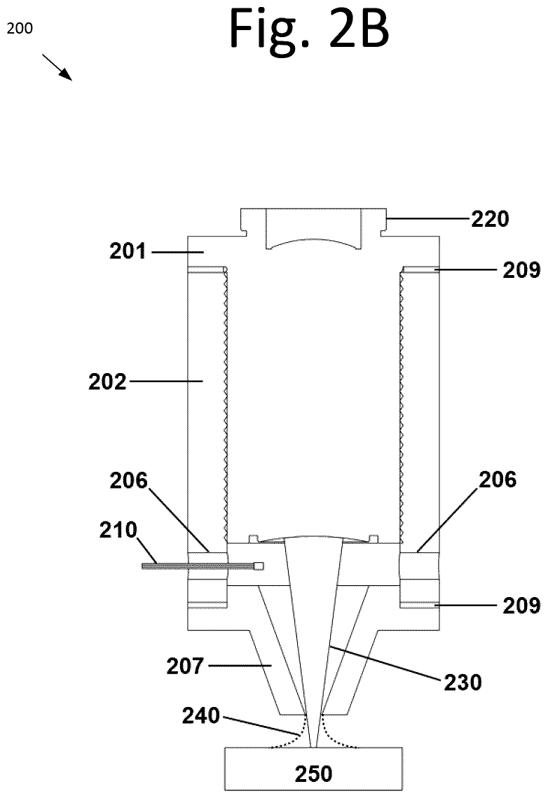

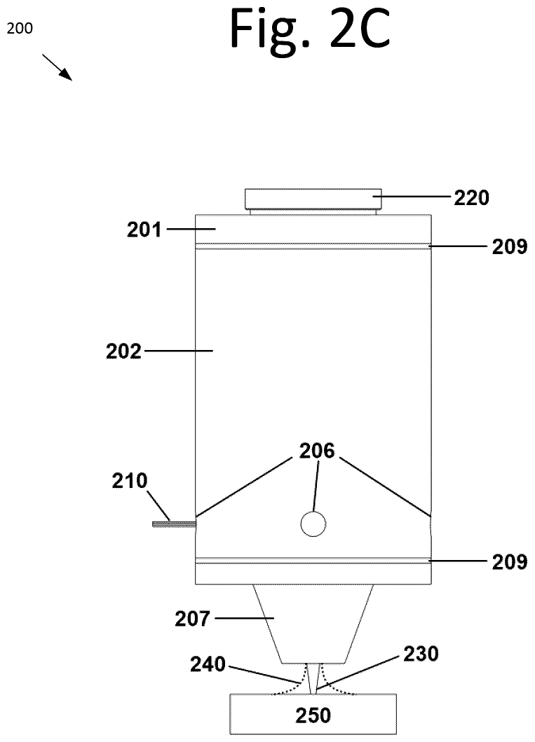

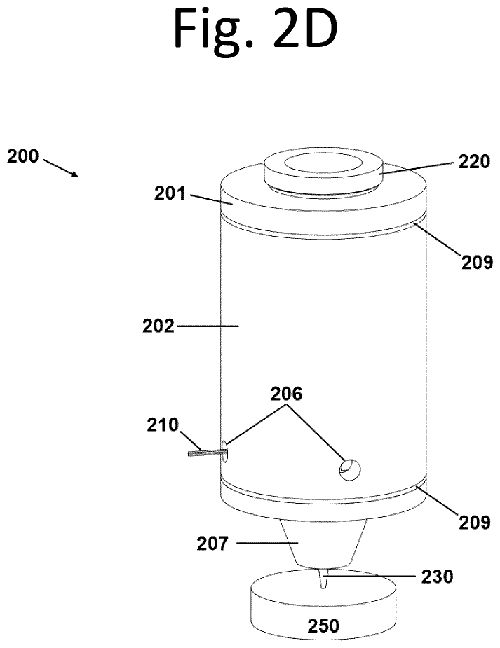

In some embodiments, the RIL uses refractive optical elements, like lens groups in microscope objectives, that are mounted within an inner body or lens housing. In this instance, the RIL typically includes an outer barrel that screws onto the inner body possessing the refractive optical elements. In another embodiment, the RIL's refractive optics are mounted within a body that is intended to be coupled directly with digital imaging sensors like CCDs. In this embodiment, the RIL possesses external mounting threads at the body's end. See, for example, FIGS. 2A-4D, which are diagrams illustrating various views of the RIL NMA device 200, 300, 400, according to an embodiment of the present invention.

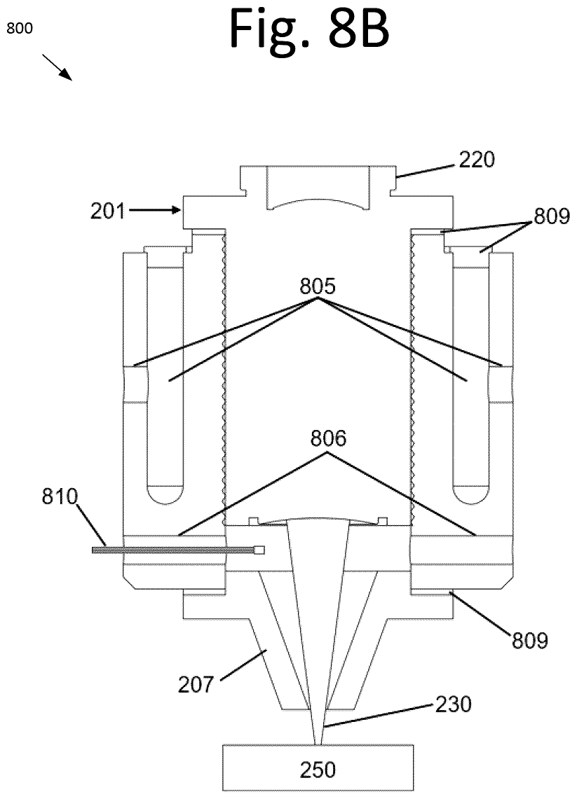

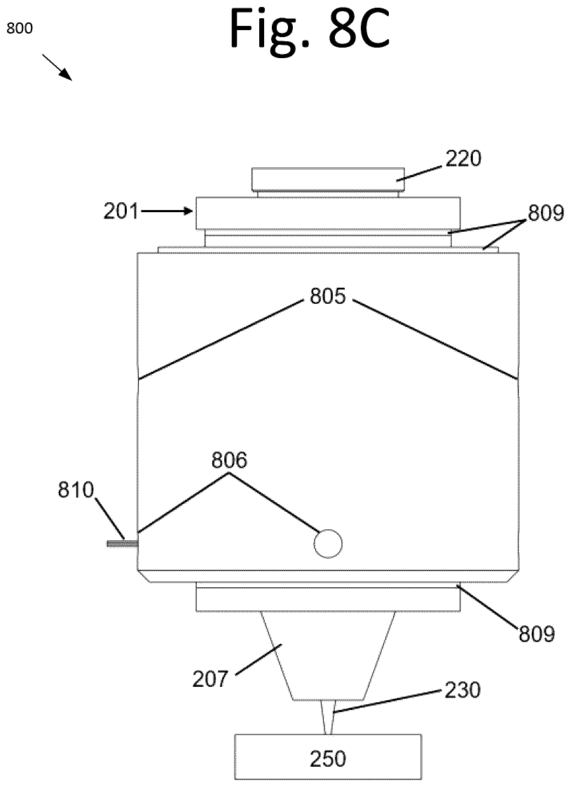

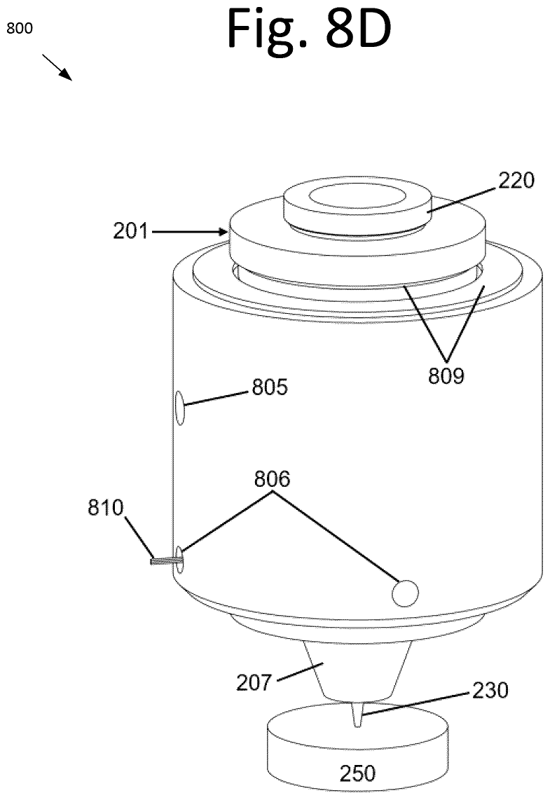

In some embodiments, such as that shown in FIGS. 2A-D, RIL NMA device 200 uses a RIL 201, nozzle manifold 202 and nozzle 207. Depending on the embodiment, RIL NMA device 200 may be constructed as a single unit, two separate units, or three or more separate units. For a single unit construction, NMA 215 features are incorporated directly into the RIL's lens housing and structure. For clarity the RIL NMA device 200 is depicted with three separate components (RIL 201, nozzle 207 and nozzle manifold 202). RIL NMA device 200 may include refractive imaging lens housing (including optics and elements) 201 and imaging lens nozzle manifold 202 with a plurality of channels, holes and bores 206 for the jet supply inlet, integrating sensors and temperature control. RIL NMA device 200 also includes a nozzle 207, gaskets (including seals, glue, etc.) 209, and a jet temperature sensor 210. In this embodiment, gaskets/seals 209 ensure the gas/liquid supplied to the RIL NMA 200 only exits through the nozzle 207 to create the impinging jet 240. Jet temperature sensor 210 is shown as being placed through one of a plurality of channels/holes/bores 206 in the nozzle manifold 202. RIL NMA device 200 can include other sensors, such as those to measure and control the jet's nozzle pressure, humidity and/or flow rate. In one embodiment, RIL NMA 200 includes pressure sensors (not shown) to measure barometric and/or nozzle differential pressure. Pressure sensors can, for example, be placed through one of a plurality of channels/holes/bores 206 in the nozzle manifold 202. In another embodiment, RIL NMA device 200 can include infrared sensors, pyrometers and cameras etc. (not shown) for measuring properties like the temperature of the jet, atmosphere, and sample 250 being inspected and analyzed. RIL NMA device 200 further includes a RIL mount for the optical system 220, RIL imaging and film thickness measurement beams 230, gas jet 240, substrate under inspection 250, and heating and cooling (not shown). The heating and cooling may be accomplished in various ways including use of a removable heating and cooling jacket, using a surface mount heater/cooler like a Peltier device, integrating channels into the nozzle manifold body like that shown in FIG. 8, or using an external heating and cooling of the jet supply.

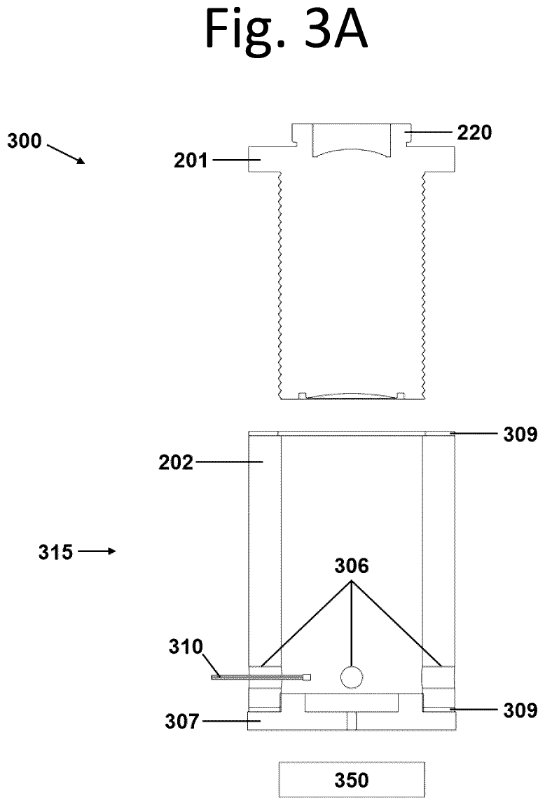

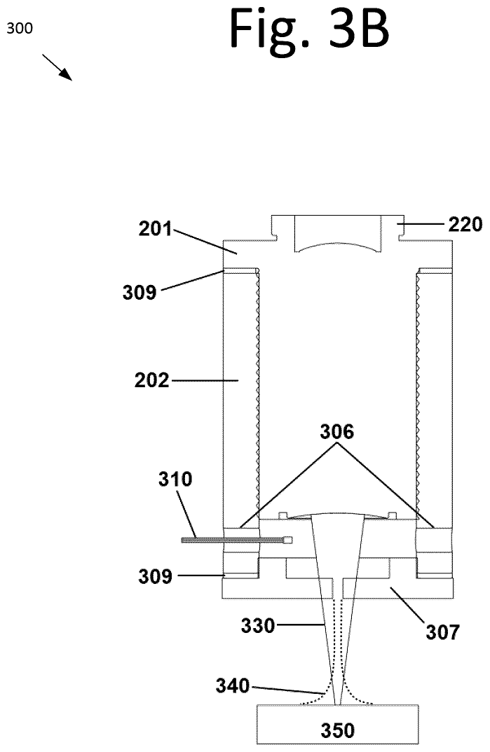

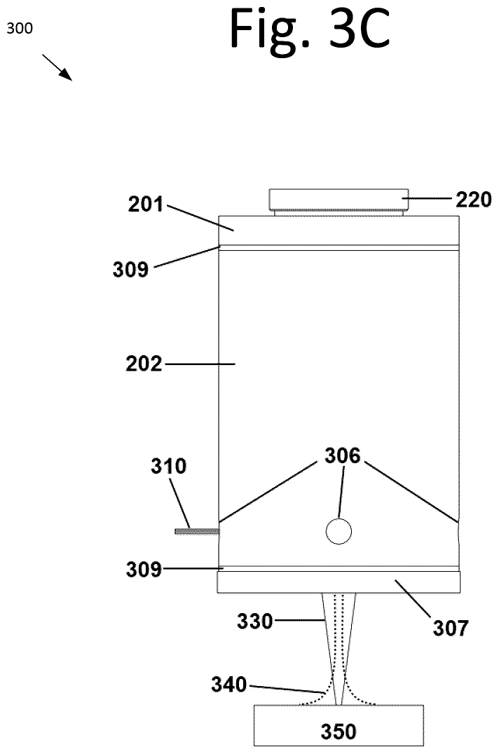

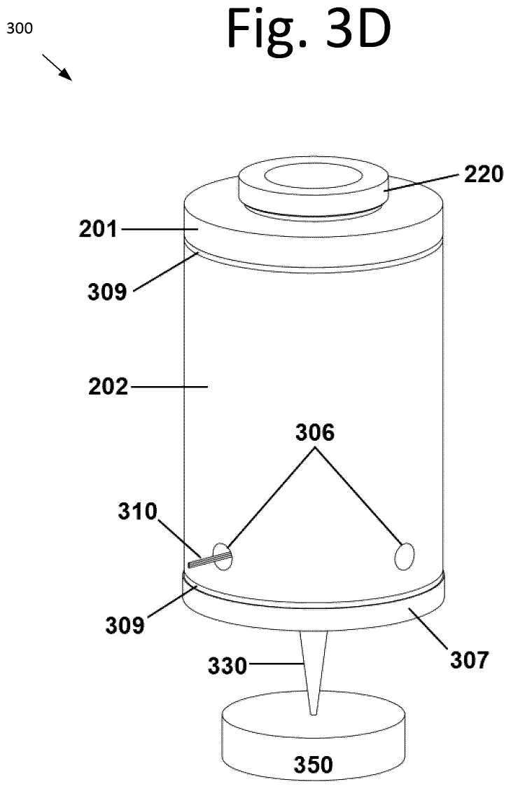

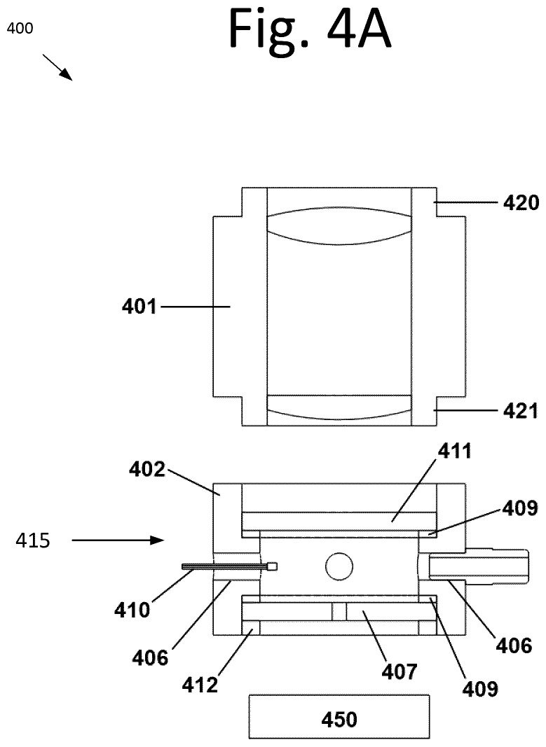

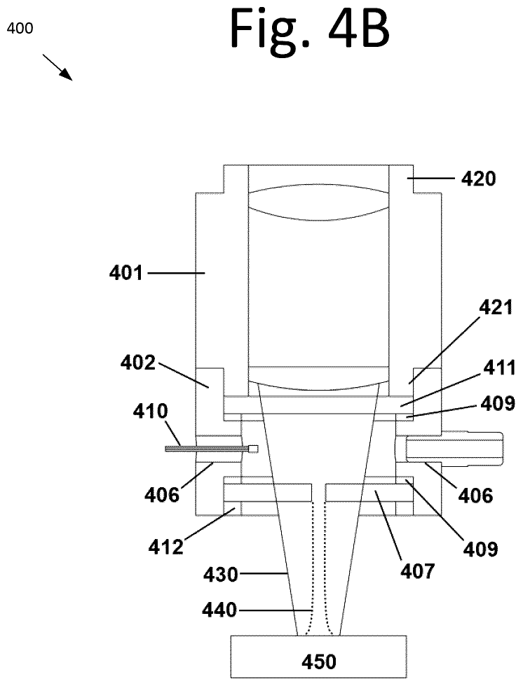

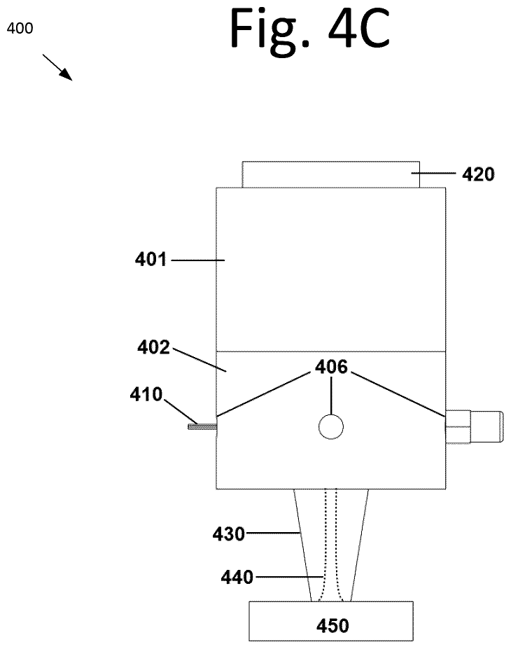

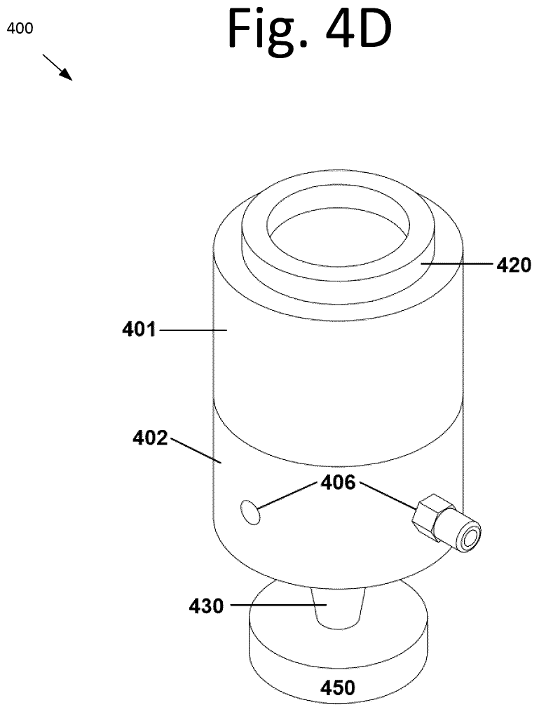

RIL NMA devices, such as those depicted in FIGS. 2A-D, beneficially do not obstruct the RIL imaging and film thickness measurement beam 230 with the nozzle during the film thinning process. Depending on the design, RIL NMA devices, such as those depicted in FIGS. 3 and 4, may obstruct the RIL imaging and film thickness measurement beam 330/430 and lead to optical artifacts that deteriorate measurement quality if the artifacts are not corrected for. However, all RIL NMAs described in this application facilitate coaxial alignment between the film thickness measurement location and/or optical image with a normal impinging jet's stagnation point. Further, the RIL NMAs allow simultaneous monitoring and control of the impinging jet, and RIL and NMA components. These RIL NMA attributes are preferred for construction of RIL-TFV instruments as they enable routine, local physical property analysis of fluids resting on solid material surfaces, simplify the thin fluid film measurement process, expand measurement protocols, improve measurement accuracy and precision, and ease theoretical analysis.

FIGS. 3A-D are diagrams illustrating various views of RIL NMA device 300, according to an embodiment of the present invention. In some embodiments, the NMA 315 may use a nozzle manifold 202 and a planar, optically transparent nozzle 307. In this embodiment, nozzle 307 may be a planar, pinhole nozzle constructed of an optically transparent material. As shown in FIG. 3B, the RIL imaging and film thickness measurement beams 330 pass through both the nozzle 307's pinhole and the transparent material that the nozzle is made of. The pinhole structure and difference in refractive index can lead to optical artifacts that degrade image and film thickness measurement quality. In instances where these artifacts are non-negligible, the RIL 201 and or nozzle 307 can be designed with optical elements to compensate for the artifacts. In other embodiments, nozzle 307 may be made of one or more pieces and possess multiple, angled orifices arranged in a radial pattern so as avoid introducing optical artifacts to the RIL imaging and film thickness beams 330. In yet another embodiment, the nozzle 307's pinhole can be made larger so that the imaging and film thickness beams 330 pass through the nozzle unobstructed.

Similar to FIGS. 2A-D, RIL NMA device 300, placed above the substrate 350 under inspection, includes a refractive imaging lens inner housing (optics and elements) 201, a plurality of channels, holes and bores 306 for the jet supply inlet, integrating sensors and temperature control, and gaskets (including seals, glue, etc.) 309. In this embodiment, the seals 309 ensure the gas/liquid supplied to the RIL NMA 300 only exits through the nozzle 307 to create the impinging jet 340. RIL NMA device 300 may also include a jet temperature sensor (shown placed through one of the plurality of bores 306 in nozzle manifold 202), RIL optical system mount 220, RIL imaging and film thickness measurement beams 330. RIL NMA device 300 may include other sensors, such as those to measure and control the jet's nozzle pressure, humidity and/or flow rate. In one embodiment, RIL NMA 300 includes pressure sensors (not shown) to measure barometric and/or nozzle differential pressure. Pressure sensors can, for example, be placed through one of a plurality of channels/holes/bores 306 in the nozzle manifold 202. In another embodiment, RIL NMA device 300 can include infrared sensors, pyrometers and cameras etc. (not shown) for measuring properties like the temperature of the jet, atmosphere, and sample 350 being inspected and analyzed. RIL NMA device 300 may further include gas jet 340 and heating and cooling system (not shown). Similar to FIG. 2, heating and cooling may be accomplished by a removable heating/cooling jacket, surface mount heater/cooler like a Peltier device, channels integrated into the nozzle manifold body similar to that shown in FIG. 8, and external heating/cooling of the jet supply.

FIGS. 4A-D are diagrams illustrating various views of RIL NMA device 400, according to an embodiment of the present invention. In this embodiment, NMA 415 uses a nozzle manifold 402, a planar, optically transparent nozzle 407 and a transparent window 411. This embodiment may be applicable to microscope objectives, machine vision zoom lens systems and commercial retail imaging products (e.g., smartphone, universal serial bus (USB) cameras, endoscopes, and microscopes to name a few). RIL NMA device 400 may be constructed in two separate parts, i.e., RIL 401 and NMA 415 with the transparent nozzle 407. When RIL 401 is, for example, a machine vision zoom lens system, the assembled NMA 415 may be mounted directly to the front of RIL 401 using mount 421. Mount 421 is a feature common to many zoom lens systems and are used to add filters, polarizers and other optical elements. Alternatively, and like the example in FIG. 2, a RIL NMA 400 can be made with a RIL that is sealed and the RIL NMA 400 can be constructed without window 411. In this embodiment, nozzle manifold 402 mounts to RIL mount 421 with gasket 409 (or other sealing method) making the seal between the two components so that the gas/liquid only exits through the nozzle to create the impinging jet. There are numerous variations of RIL NMA 400 that depend on RIL construction and design.

As shown in FIGS. 4B-D, the RIL imaging and film thickness measurement beams 430 pass through both the nozzle 407's pinhole and the transparent material that the nozzle is made of. The pinhole structure and difference in refractive index can lead to optical artifacts that degrade image and film thickness measurement quality. In instances where these artifacts are non-negligible, the RIL 401 and or nozzle 407 can be designed with optical elements to compensate for the artifacts. In other embodiments, nozzle 407 may be made of one or more pieces and possess multiple, angled orifices arranged in a radial pattern so as to avoid introducing optical artifacts to the RIL imaging and film thickness beams 430. In yet another embodiment, the nozzle 407's pinhole can be made larger so that the imaging and film thickness beams 430 pass through the nozzle unobstructed.

As depicted in FIGS. 4A-D, RIL NMA device 400, placed above substrate 450 under inspection, may also include a plurality of channels, holes and bores 406 for jet supply inlet, integrating sensors and temperature control. It should be appreciated that a “tube fitting”, which is shown screwed into channels/bores 406, connects the gas supply to NMA 415 using a tapped hole 406, in some embodiments. RIL NMA 400 may further include gaskets (including seals, glue, etc.) 409, jet temperature sensor 410, transparent window 411, one or more fastener(s) 412, RIL optical system mount 420, RIL mount 421 to nozzle manifold 402, RIL imaging and film thickness measurement beams 430, gas jet 440, and heating/cooling (not shown). Depending on the embodiment, RIL NMA device 400 may include other sensors such as those to measure and control the jet's nozzle pressure, humidity and/or flow rate. In an embodiment, RIL NMA 400 includes pressure sensors (not shown) to measure barometric and or nozzle differential pressure. Pressure sensors can, for example, be placed through one of a plurality of channels/holes/bores 406 in the nozzle manifold 402. In another embodiment, RIL NMA device 400 can include infrared sensors, pyrometers and cameras etc. (not shown) for measuring properties like the temperature of the jet, atmosphere, and sample 450 being inspected and analyzed. As previously discussed, heating and cooling may be achieved by using removable heating/cooling jacket, surface mount heater/cooler like a Peltier device, channels integrated into the nozzle manifold body similar to that shown in FIG. 8, and external heating/cooling of the jet supply.

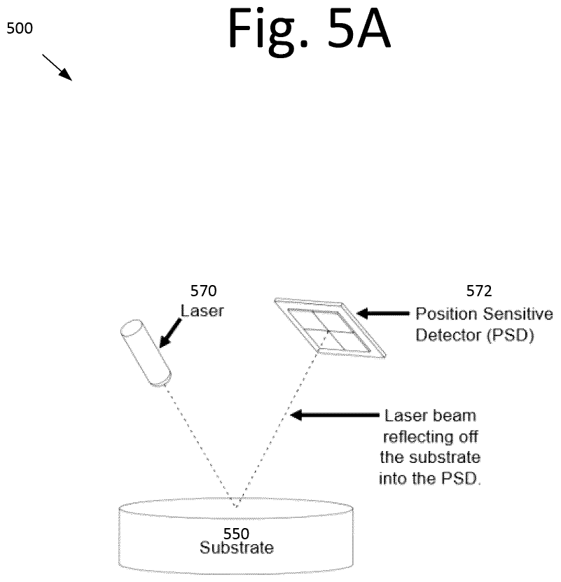

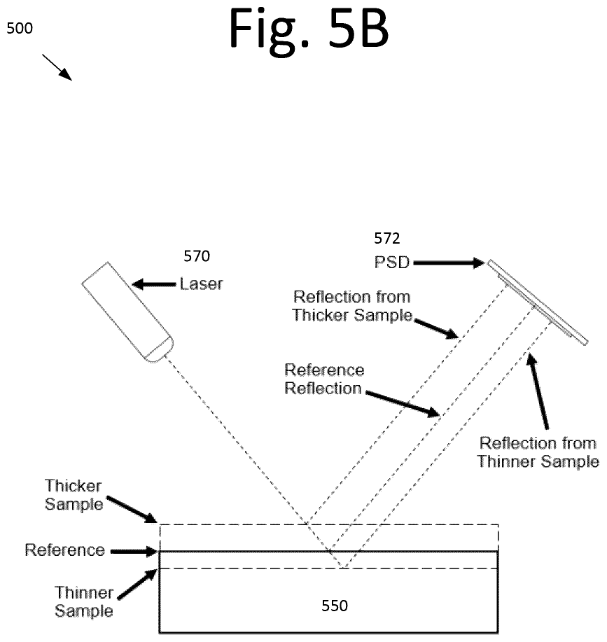

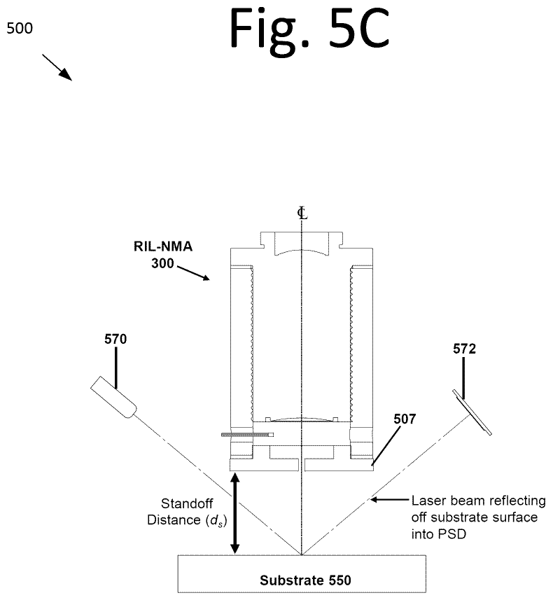

FIGS. 5A-C are diagrams illustrating a configuration 500 for triangulating with a position sensitive detector (PSD) 572, according to an embodiment of the present invention. In this embodiment, laser 570 transmits a laser beam towards substrate 550, in which the laser beam reflects off substrate 550's surface into PSD 572. Substrate 550 and sample (not shown) may be one in the same depending on the embodiment. It should be noted that, depending on the thickness of the sample, the position of reflection into PSD 572 may change. See, for example, FIG. 5B. More specifically, PSD 572 measures a high laser position for a substrate thicker than the reference substrate. This reading instructs the user to move the RIL NMA or substrate vertically until the PSD reading matches the value recorded during background measurement with the reference sample. For instance, in FIG. 5B, PSD 572 may record “0” during background measurements with the reference sample. Now, when the thicker sample is measured, PSD 572 records a high value. The user may move the RIL NMA or sample vertically until PSD 572 sees “0” to match the reference value. Once matched to “0”, the user proceeds to make optical, film thickness and viscosity measurements.

As shown in FIG. 5C, in this embodiment, laser 570-PSD 572 triangulation is used to monitor and control the RIL NMA 300's nozzle 507 position relative to substrate 550's surface. This triangulation ensures the standoff distance (dₛ) is highly repeatable when making film thickness, TFV viscosity and other measurements. FIG. 5C illustrates a general arrangement and alignment of the laser 570-PSD 572 about the RIL NMA 300 and the centerline that corresponds to the RIL NMA's optical axis, image center, focal point, measurement location and impinging jet stagnation point. The laser 570 and PSD 572, in some embodiments, are incorporated into the RIL NMA 300 in various ways including permanent integration or as a removable component, which can be used with different RIL NMAs such as those with different magnifications. Whether permanently integrated or as a removable component, the fixture for laser 570 and PSD 572 includes the ability to adjust their position, say with angle and xyz positioners, so that the point where the laser spot reflects off the substrate coincides with the centerline, which corresponds to the RIL NMA's optical axis, image center and focal point, measurement location and jet stagnation point. Laser 570 and PSD 572 for triangulation may also be integrated into the TFV instrument, e.g., on structural components that the RIL NMA is mounted on in the TFV.

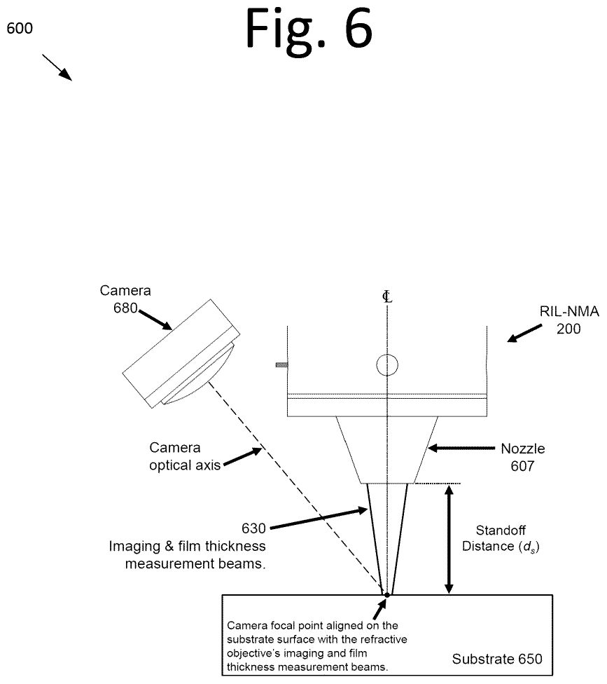

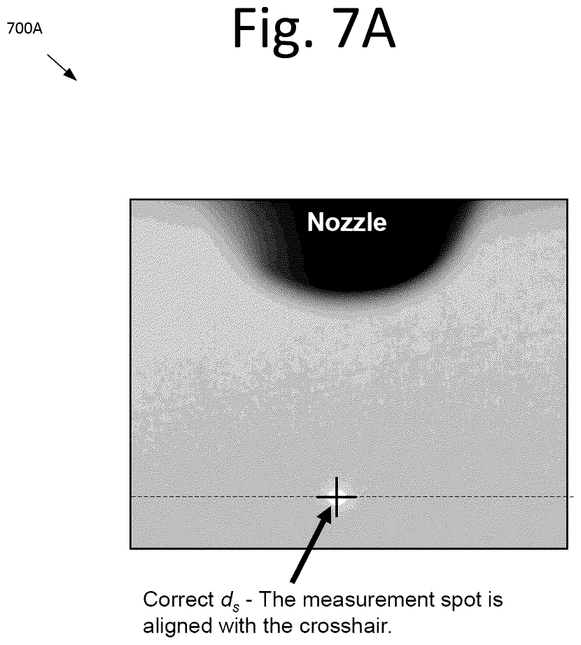

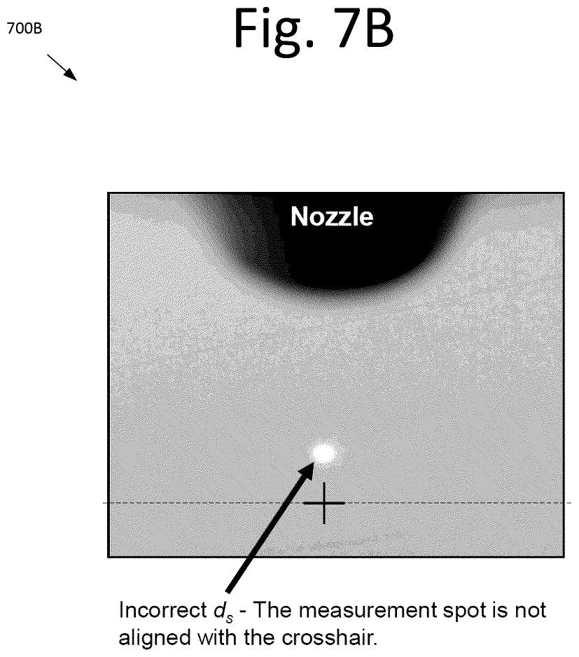

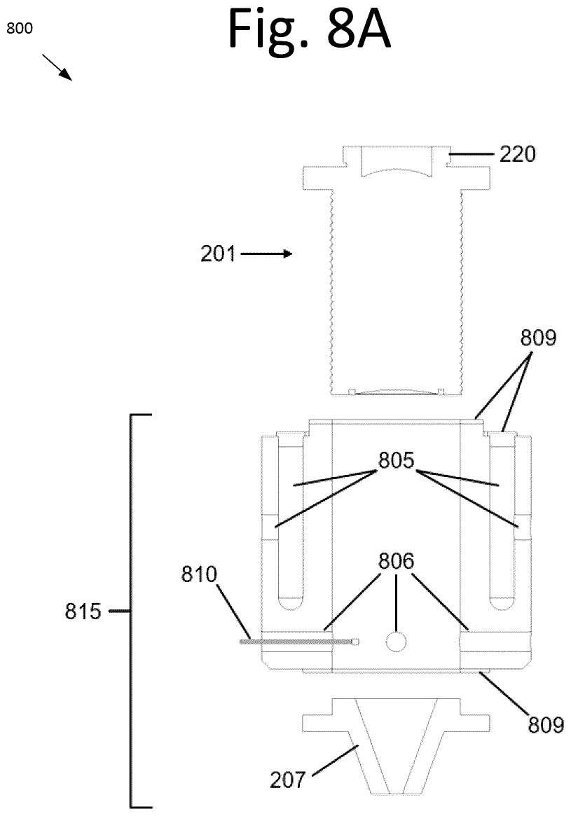

FIG. 6 is a diagram illustrating a camera triangulation schematic 600, according to an embodiment of the present invention. In this embodiment, a camera 680 is arranged at an oblique angle relative to RIL NMA 200. When at the correct standoff distance dₛ, the camera 680's focal point and RIL NMA 200's measurement spot are aligned on the surface of substrate 650. See, for example, FIGS. 7A and 7B, which show images 700A and 700B illustrating use of camera triangulation, according to an embodiment of the present invention. In image 700A, the correct standoff distance is shown, i.e., at the correct standoff distance dₛ, the camera focal point and the measurement spot are aligned on the substrate surface. In image 700B, the incorrect standoff distance dₛ is shown, i.e., the measurement spot is not aligned with the crosshair. In this case, when standoff distance dₛ is incorrect, the RIL NMA or sample is moved vertically to align the measurement spot with the crosshair. Camera 680 can be incorporated into the RIL NMA 200 in various ways including permanent integration or as a removable component that can be used with different RIL NMAs like those with different magnifications. Whether permanently integrated or as a removable component, camera 680 can include the ability to adjust its position, say with angle and xyz positioners, so camera 680's focal point and image center coincides with the centerline, which corresponds to the RIL NMA's optical axis, image center and focal point, measurement location and jet stagnation point. Camera 680 may also be integrated into the TFV instrument, e.g., on structural components that the RIL NMA is mounted to.

FIGS. 8A-D are diagrams illustrating various views of a RIL NMA 800 with the integrated heat-cooling features for temperature control, according to an embodiment of the present invention. In some embodiments, the temperature of RIL NMA, and therefore, the gas jet is controlled in various ways including direct integration of heaters/coolers into NMA 815, placement of RIL NMA based instruments in a temperature-controlled environment, external conditioning of the gas jet supply and use of removable heating/cooling elements. More specifically, FIG. 8 shows a removable NMA 815 with integrated features for heating-cooling that mounts to a RIL. As shown in FIG. 8, RIL NMA 800 possesses similar features as RIL NMA 200 that are included by reference, but also includes inlet outlet ports to supply temperature-controlled media, e.g. fluid, from a recirculating heater-chiller, for example. A removable NMA 815 like this may be beneficial in applications where different RILs are used, allowing transfer of the NMA 815 from one RIL to another. It should be appreciated that the NMA type shown in these embodiments, with heating and cooling, may also be combined with the laser-PSD and camera triangulation, as shown in FIGS. 5-7.

In these embodiments, NMA 815 includes a plurality of inlet/outlet ports and channels 805 for heating and cooling media. Similar to RIL NMA 200, there are also a plurality of channels, holes and bores 806 used for the jet supply inlet, integrating sensors and temperature monitoring-control. NMA 815 further includes nozzle 207, gaskets (seals, glues, etc.) 809 and jet temperature sensor 810. It should be appreciated that, although nozzle 207 for NMAs are removable, in certain embodiments, nozzle 207 may be permanent (i.e., integrated into the NMA as a single unit).

FIG. 8A shows a diagram with the RIL 201, NMA 815 and nozzle 207 as separate components prior to assembling into the RIL NMA 800. FIGS. 8B-D show the assembled RIL NMA 800 above substrate 250 with the RIL imaging and film thickness measurement beams 230 coaxially aligned and exiting the nozzle 207. RIL NMA device 800 can include other sensors like those to measure and control the jet's nozzle pressure, humidity and/or flow rate. In one embodiment, RIL NMA 800 includes pressure sensors (not shown) to measure barometric and or nozzle differential pressure. Pressure sensors can, for example, be placed through one of a plurality of channels/holes/bores 806 in the NMA 815. In another embodiment, RIL NMA device 800 can include infrared sensors, pyrometers, and cameras etc. (not shown) for measuring properties like the temperature of the jet, atmosphere, and sample 250 being inspected and analyzed.

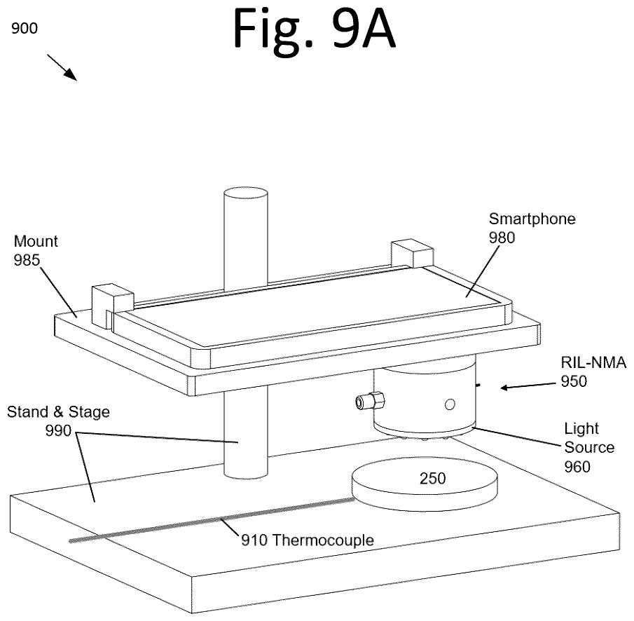

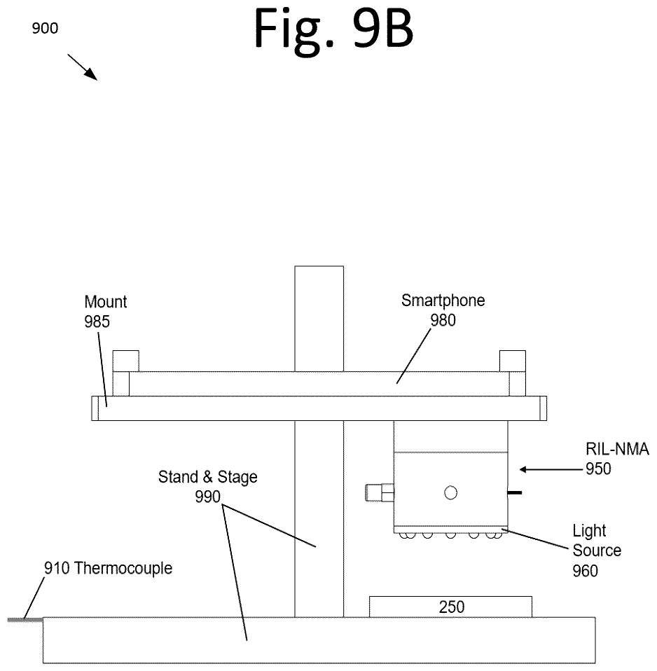

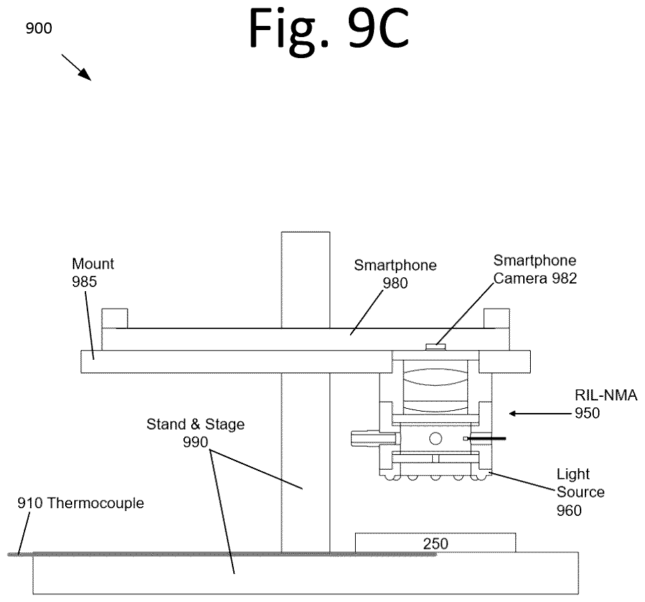

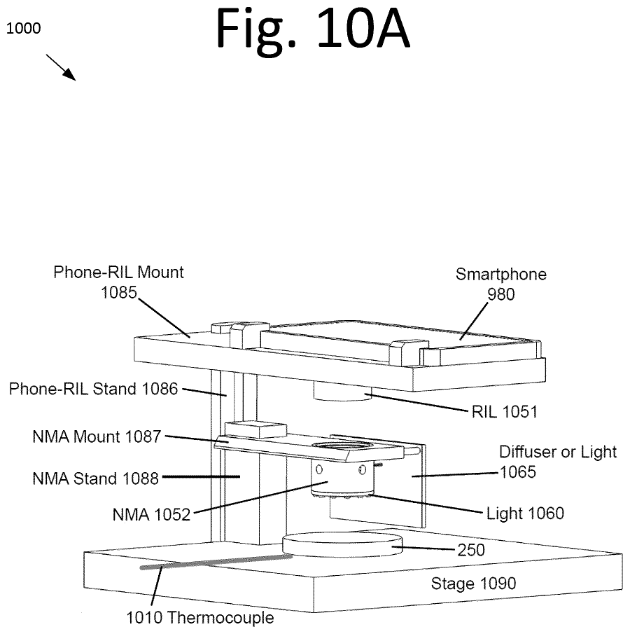

FIGS. 9A-C are diagrams 900 illustrating various views of a RIL NMA 950 coupled to a smartphone device 980, according to an embodiment of the present invention. In some embodiments, RIL NMA 950 is coupled to microscope objectives, machine vision zoom lens systems and retail imaging products such smartphones 980 and digital cameras, and USB devices such as cameras, endoscopes and microscopes. In some instances, the RIL used in the RIL NMA 950 is a lens for magnification. In other instances, RIL NMA 950 may exclude the RIL and therefore the NMA couples directly to the smartphone device 980. In these embodiments, RIL NMA 950 is coupled to a smartphone 980 for inspection and analysis of sample surfaces 250 (including surfaces coated with fluid films).

RIL NMA 950 has similar components and features as RIL NMA 400 that are not labeled for clarity. This includes the RIL and the NMA comprised of a nozzle manifold, a planar, optically transparent pinhole nozzle and a transparent window. As with RIL NMA 400, RIL NMA 950 includes a plurality of channels, holes and bores for jet supply inlet, integrating sensors and temperature control, gaskets (including seals, glue, etc.), jet temperature sensor, one or more fastener(s), RIL imaging and film thickness measurement beams (not shown). As previously discussed, heating and cooling of RIL NMA 900 may be achieved by using removable heating/cooling jacket, surface mount heater/cooler like a Peltier device, channels integrated into the nozzle manifold body similar to that shown in FIG. 8, and external heating/cooling of the jet supply.

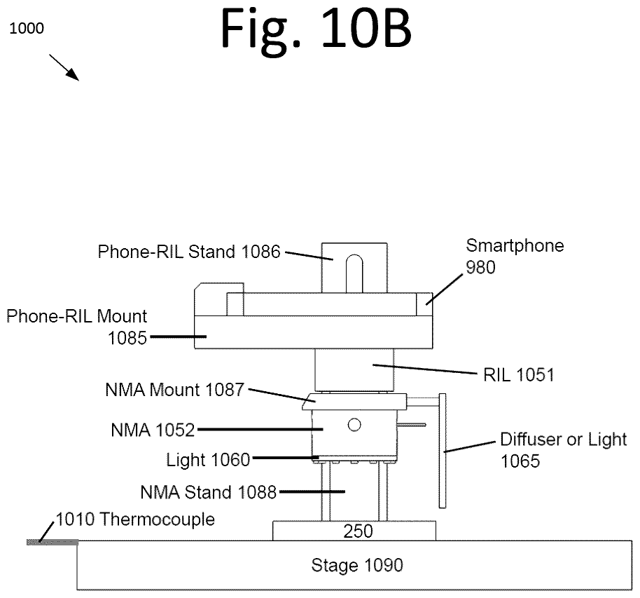

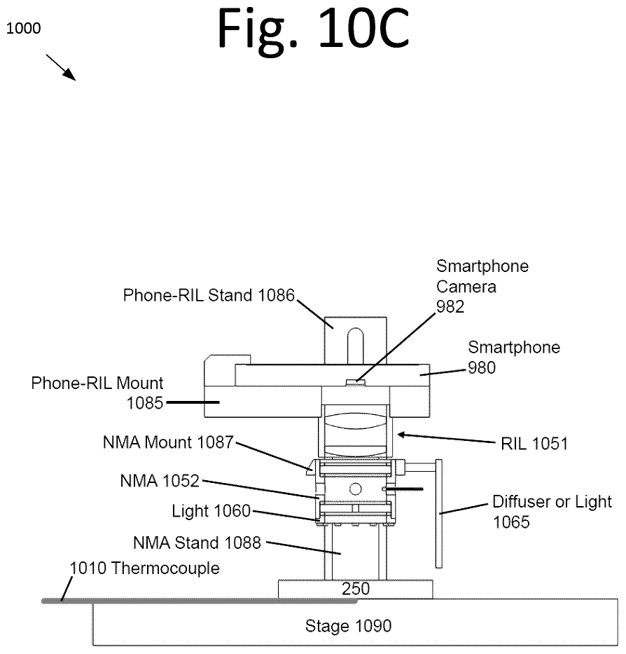

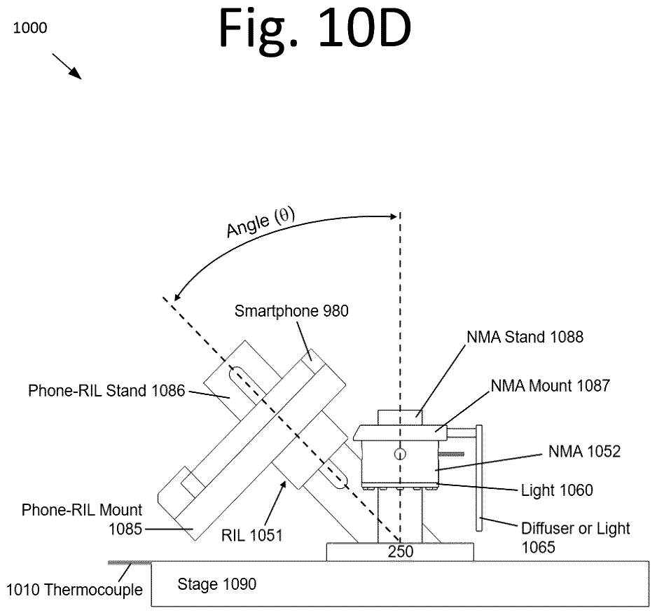

In FIG. 9A, RIL NMA 950 is coupled to a smartphone 980 using a mount 985, and stand and stage 990. In this diagram, smartphone 980 and RIL NMA 950 are attached to a common mount 985 so that optical axis of RIL NMA 950 and smartphone 980 camera are aligned and perpendicular to the stage and sample 250's surface. The common mount 985 is able to move vertically, and therefore moves the mounted RIL NMA 950 and smartphone 980 camera so that sample 250's surface can be brought into focus and measurements made at the correct standoff distance (dₛ) as discussed previously. The stand and stage 990 may include physical markings, like a ruler, or a position encoder to facilitate accurate vertical positioning. In another embodiment, one can use a modular configuration with multiple mounts that allows the RIL and NMA axes to be positioned relative to each other. In one case, as shown in FIG. 10A-D, smartphone 980 and RIL are placed on one mount that allows variable angular positioning and imaging, while the NMA is placed on another mount that can move vertically however has a fixed angular position with its nozzle axis perpendicular to the stage and sample.

In FIGS. 9A-C, light source 960 is shown attached to the exterior of RIL NMA 950 but light can also be guided within RIL NMA 950 for epi-illumination, which is commonly used for reflective imaging. Depending on the embodiment, installing multiple light sources may be beneficial, e.g., a light placed within the stage for inspection of transparent samples (not shown). Stand and stage 990 may include a plurality of features and sensors, such as fixtures to hold and/or position the sample, and thermocouple(s) 910, infrared sensors, pyrometers and/or cameras, etc. (not shown) for measuring properties like the temperature of the jet, atmosphere, and sample 250 being inspected and analyzed.

In FIG. 9B-C, RIL NMA 900 is coupled to smartphone 980, where light source 960 is shown to be attached to the exterior of RIL NMA 900. In some embodiments, however, light source 960 may be placed within RIL NMA 900 for epi-illumination. Multiple light sources may also be beneficial such as within the stage for transparent samples (not shown).

FIGS. 10A-D are diagrams illustrating various views of a modular RIL NMA 1000 coupled to a smartphone 980, according to an embodiment of the present invention. In some embodiments, modular RIL NMA 1000 is made with a smartphone 980 using a phone RIL mount 1085, phone RIL stand 1086, NMA mount 1087, NMA stand 1088 and stage 1090. In these embodiments, two separate mounts and stands, i.e., phone RIL mount/stand 1085/1086 and NMA mount/stand 1087/1088 are used. Phone RIL mount 1085 is used to couple the smartphone and RIL 1051, where in some embodiments RIL 1051 is a lens for magnification. NMA mount 1087 and stand 1088 are used to hold the NMA 1052 and light diffuser or light source 1065 above sample 250 placed on stage 1090. The stage 1090, phone RIL mount 1085, phone RIL stand 1086, NMA mount 1087 and NMA stand 1088 may include a plurality of features and sensors, such as fixtures to hold the and position components and sample, and thermocouple(s) 1010, infrared sensors, pyrometers and/or cameras, etc. (not shown) for measuring properties like the temperature of the jet, atmosphere and sample 250 being inspected and analyzed.

The modular configuration allows smartphone-RIL and NMA axes to be positioned relative to each other. In this embodiment, the smartphone-RIL is placed on phone RIL mount 1085 which is attached to phone RIL stand 1086 that allows both vertical and angular (θ) positioning, while the NMA is placed on NMA mount 1087 which is attached to NMA stand 1088 that allows vertical positioning of NMA 1052 with the nozzle axis perpendicular to the stage. For imaging at an angle, a light source or light diffuser 1065 is shown attached to NMA mount 1087. It is understood that there are various mounting design configurations, where for example NMA mount 1087 and NMA stand 1088 can be designed to allow variable angular positioning of the NMA 1052.

In certain embodiments, such as that shown in FIG. 10D, a modular RIL NMA 1000 with two separate mounts/stands, i.e., phone RIL mount/stand 1085/1086 and NMA mount/stand 1087/1088 may be used. In these embodiments, the smartphone-RIL is positioned at an angle (θ) during imaging, while the NMA's nozzle axis is perpendicular to the sample and stage. During imaging, the light 1060, light or light diffuser 1065 shown attached to NMA mount 1087 can be used to improve image-video quality.

As depicted in FIGS. 10A-D the two separate mounts (e.g., phone RIL mount 1085 and NMA mount 1087) are able to move vertically on their respective stands. This allows both the smartphone-RIL and NMA 1052 to be moved independently so that the surface of sample 250 can be brought into focus and measurements made at the correct standoff distance (dₛ) as discussed previously. The phone RIL mount 1085, phone RIL stand 1086, NMA mount 1087, NMA stand 1088, and stage 1090 may include physical markings, like a ruler, or position encoders to facilitate accurate vertical positioning and sample placement. FIG. 10A shows the smartphone-RIL separated from the mounted NMA while FIG. 10B shows the smartphone-RIL moved to the correct position to conduct measurements.

In FIGS. 10A-D, light source 1060 is shown attached to the exterior of NMA 1052 but light can also be guided within NMA 1052 for epi-illumination, which is commonly used for reflective imaging. Depending on the embodiment, installing multiple light sources may be beneficial, e.g., a light placed within the stage for inspection of transparent samples (not shown).

Also, shown in FIG. 10A-D is a light diffuser or light source 1065. In some embodiments, light diffuser or light source 1065 is configured to provide a white background to which substrate 250 is superimposed thereon. In some further embodiments, light diffuser or light source 1065 may include a diffuse light source such as a light emitting diode (LED) or red, green, blue (RGB) panel. Another way to say the same thing is, the diffuser is superimposed onto substrate 250.

It should be appreciated that, depending on the embodiment, the NMA described herein may be a separate component that attaches to a functional RIL. In some embodiments, both NMA and RIL are functional devices on their own. The embodiments with RIL NMA may be one assembled component and may not be readily separated from each other.

Certain embodiments may use a diffuse light source, such as a small LED panel, that replaces the diffuser but also provides the same function (i.e., improve lighting, image quality and contrast of the sample being analyzed and of the stagnation zone during measurements). An RGB panel with color control in other embodiments may be used to track interference fringes inside and outside the measurement location and should allow reconstructing 3D thickness maps from the images.

All the RIL NMA devices described in FIGS. 1-10 may be used to construct Coaxial Thin Film Viscometers (CTFV), a preferred type of TFV instrument that can measure the interfacial-rheological-optical properties of thin fluid films and the surfaces that they coat. CTFVs ensure coaxial alignment of the imaging and film thickness measurement location with an impinging jet's stagnation point, while simultaneously monitoring and controlling the impinging jet. With high precision components, such as machining and assembly, a person of ordinary skill in the art may construct the RIL NMA without positioners to align the imaging and film thickness measurement location with the nozzle and impinging jet's stagnation point (i.e., align their respective centers and or centerlines). In this regard, the components are fixed once assembled and in principle would not require further adjustment. For purposes of explanation/clarification, it may be beneficial to include positioners within the NMA, nozzle and or RIL so that the components can be moved relative to each other by the user. Positioners may include mounting features with precision adjustment screws and stages that give the user flexibility to make measurements when coaxially aligned or to make measurements outside the stagnation point/zone. When positioners are included, there are several positioner combinations, however it is a matter of design choice which component(s) (RIL, NMA, nozzle, etc.) the positioners are incorporated into. During practice, a person of ordinary skill in the art may fix one, say the RIL, and have XYZ translation for the other components.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A nozzle manifold assembly (NMA) for a refractive imaging lens (RIL), comprising:
a nozzle manifold (“manifold”) and a nozzle being part of the NMA, wherein
the manifold is configured to direct fluid into the nozzle to form a jet, and is configured to mount to the nozzle, and
the manifold comprising a plurality of sensors and/or devices configured to measure and/or control one or more properties of the NMA, the RIL, and/or the jet; and
a fluid supply connected to, and supplying fluid through, the manifold to form the jet.

2. The NMA of claim 1, wherein the RIL comprises a plurality of refractive optics, and is configured to transmit one or more optical beams,
the one or more optical beams are comprised of one or more imaging beams, one or more film thickness measurement beams, or both.

3. The NMA of claim 1, wherein the NMA is mounted to, attached to, or integrated into, the RIL, and together
placed in proximate location to a fluid surface having a standoff distance d relative to a tip of the nozzle, or
placed in proximate location to a substrate having a standoff distance d relative to a surface of the substrate.

4. The NMA of claim 1, further comprising:
a laser configured to emit laser beam towards a fluid, fluid film and/or a substrate in which the laser beam reflects off of the fluid, fluid film and/or the substrate and towards a position sensitive detector (PSD).

5. The NMA of claim 4, wherein the PSD is configured to measure the laser position for the fluid, fluid film or the substrate with respect to a reference.

6. The NMA of claim 1, further comprising:
a camera arranged at an oblique angle relative to the RIL NMA, wherein
the camera comprises a focal point aligned on a surface of the substrate, thin film, and/or the fluid with a refractive objective's imaging and/or film thickness measurement beams.

7. The NMA of claim 1, further comprising:
a plurality of inlet and/or outlet ports and channels configured for heating and cooling media; and
a plurality of channels, holes and bores used for a jet supply inlet, integrating sensors and temperature monitoring and control.

8. The NMA of claim 1, wherein the NMA is a separate component from the RIL NMA prior to combining the NMA with the RIL.

9. The NMA of claim 8, further comprising:
a mount and/or stage configured to couple an imaging device to the combined RIL NMA, wherein
the imaging device and the combined RIL NMA are attached to the mount such that an optical axis of the combined RIL NMA and the imaging device are aligned and perpendicular to the thin film, fluid surface, and/or the substrate.

10. The NMA of claim 9, wherein the mount is configured to move vertically bringing a surface of the substrate, thin film and/or fluid into focus with a camera of the imaging device and the RIL NMA.

11. The NMA of claim 1, further comprising:
a plurality of positioners within the NMA, the optical beam, the nozzle, the RIL, laser, and/or PSD, wherein each of the plurality of positioners are configured to move one or more components of the NMA, the nozzle, RIL, laser, and/or PSD relative to each other, the thin fluid film and/or the substrate.

12. The NMA of claim 1, further comprising:
a NMA mount configured to mount the NMA above the substrate; and
a imaging device mount configured to mount a imaging device above the NMA.

13. The NMA of claim 12, wherein the imaging device mount is configured to couple the RIL and the imaging device such that the RIL acts as a lens for magnification.

14. The NMA of claim 12, further comprising:
an imaging device stand configured to vertically and angularly move the imaging device, RIL, RIL coupled to the imaging device, and/or the NMA, and/or
a NMA stand configured to vertically and angularly move the mounted NMA relative to the RIL, imaging device, or both.

15. The NMA of claim 1, wherein the NMA comprises one or more light sources configured to illuminate the thin film and/or substrate during operation.

16. The NMA of claim 1, wherein each of the plurality of sensors are configured to measure and/or control one or more physical properties of the NMA, the RIL, the RIL NMA, and/or the jet.

17. A nozzle manifold assembly (NMA) refractive imaging lens (RIL) system, comprising:
a nozzle manifold (“manifold”) and a nozzle being part of the NMA, wherein
the manifold is configured to direct fluid into the nozzle to form a jet, and is configured to mount to the nozzle, and
the manifold comprising a plurality of sensors and/or devices configured to measure and/or control one or more properties of the NMA, the RIL, and/or the jet; and
a fluid supply connected to, and supplying fluid through, the manifold to form the jet, wherein
the NMA is mounted to, attached to, or integrated into, the RIL, and together
placed in proximate location to a fluid film having a standoff distance d relative to a tip of the nozzle, or
placed in proximate location to a substrate having a standoff distance d relative to a surface of the substrate

18. The system of claim 17, wherein the RIL comprises a plurality of refractive optics, and is configured to transmit one or more optical beams,
the one or more optical beams are comprised of one or more imaging beams, one or more film thickness measurement beams, or both.

19. The system of claim 17, further comprising:
a laser configured to emit laser beam towards a fluid, fluid film and/or a substrate in which the laser beam reflects off of the fluid, fluid film and/or the substrate and towards a position sensitive detector (PSD).

20. The system of claim 19, wherein the PSD is configured to measure the laser position for the fluid, fluid film and/or the substrate with respect to a reference.

21. The system of claim 17, further comprising:
a camera arranged at an oblique angle relative to the RIL NMA, wherein
the camera comprises a focal point aligned on a surface of the substrate, thin film, and/or the fluid with a refractive objective's imaging and/or film thickness measurement beams.

22. The system of claim 17, further comprising:
a plurality of inlet and/or outlet ports and channels configured for heating and cooling media; and
a plurality of channels, holes and bores used for a jet supply inlet, integrating sensors and temperature monitoring and control.

23. The system of claim 17, wherein the NMA is a separate component from the RIL NMA prior to combining the NMA with the RIL.

24. The system of claim 23, further comprising:
a mount and/or stage configured to couple an imaging device to the combined RIL NMA, wherein
the imaging device and the combined RIL NMA are attached to the mount such that an optical axis of the combined RIL NMA and the imaging device are aligned and perpendicular to the thin film, fluid surface, and/or the substrate.

25. The system of claim 24, wherein the mount is configured to move vertically bringing a surface of the substrate, thin film and/or fluid into focus with a camera of the imaging device and the RIL NMA.

26. The system of claim 17, further comprising:
a plurality of positioners within the NMA, the optical beam, the nozzle, the RIL, laser, and/or PSD, wherein each of the plurality of positioners are configured to move one or more components of the NMA, the nozzle, RIL, laser, and/or PSD relative to each other, the thin fluid film and/or the substrate.

27. The system of claim 17, further comprising:
a NMA mount configured to mount the NMA above the substrate; and
a imaging device mount configured to mount a imaging device above the NMA.

28. The NMA of claim 27, wherein the imaging device mount is configured to couple the RIL and the imaging device such that the RIL acts as a lens for magnification.

29. The NMA of claim 27, further comprising:
an imaging device stand configured to vertically and angularly move the imaging device, RIL, RIL coupled to the imaging device, and/or the NMA, and/or
a NMA stand configured to vertically and angularly move the mounted NMA relative to the RIL, imaging device, or both.

30. The system of claim 17, wherein the NMA comprises one or more light sources configured to illuminate the thin film and/or substrate during operation.

31. The system of claim 17, wherein each of the plurality of sensors are configured to measure and/or control one or more physical properties of the NMA, the RIL, the RIL NMA, and/or the jet.
